(19) United States
(12) Patent Application Publication
(10) Pub. No.: US 2012/0009322 A1
(43) Pub. Date: Jan. 12, 2012

(54) COOKED FOODS CONTAINING CONJUGATED LINOLEIC ACIDS

(76) Inventor: David G. Changaris, Louisville, KY (US)

(21) Appl. No.: 13/235,680

(22) Filed: Sep. 19, 2011

Related U.S. Application Data
(63) Continuation of application No. 11/286,499, filed on Nov. 23, 2005, now abandoned.

(51) Int. Cl. A23L 1/168; A23L 1/01; A23L 1/305

(52) U.S. Cl. 426/622

(57) ABSTRACT

The invention comprises a cooked food comprising an ingredient selected from the group consisting of a prepared conjugated linoleic acid, an ester thereof, a non-toxic salt thereof, diglyceride and triglyceride esters of various isomers of conjugated linoleic acids, conjugated dienes of long-chained fatty acids, and mixtures thereof, said ingredient being present in an amount of at least 3 milligrams per gram of lipid in the food. A portion of the ingredient is present in the food after cooking.

### CROSS-REFERENCE TO RELATED APPLICATIONS

The present application is a Continuation Application of U.S. patent application Ser. No. 11/286,499 and claims priority to and incorporates by reference U.S. patent application Ser. No. 11/286,499, titled “COOKED FOODS CONTAINING CONJUGATED LINOLEIC ACIDS”, filed Nov. 23, 2005.

### BACKGROUND

1. Field of the Invention

The present invention relates to cooked foods incorporating conjugated linoleic acids. More particularly, it relates to cooked foods for humans and animals that are made from grain and incorporate conjugated linoleic acids.

2. Description of Related Art

Linoleic acids are polyunsaturated 18-carbon fatty acids. Conjugated linoleic acids (CLAs) are a type of linoleic acid having two double-bonded carbon atoms on either side of another carbon atom. CLAs and their derivatives—including esters, non-toxic salts, diglyceride and triglyceride esters of various isomers of conjugated linoleic acids, conjugated dienes of long-chained fatty acids, and mixtures thereof—have been shown to have many beneficial properties when ingested by animals and humans. These benefits include increased metabolic rate, decreased abdominal fat, enhanced muscle growth, lower cholesterol, reduced food-induced allergic reactions, and a generally enhanced overall immune response. In addition, CLAs have also been shown to fight cancer in animal studies.

Unfortunately, CLAs are not extremely stable molecules, and they are well-known to be sensitive to oxidative injury and extreme temperatures. When exposed to air and high temperatures, CLAs denature easily and rapidly, so they have not been incorporated effectively into cooked foods. Consequently, CLAs are typically served as a dietary supplement or as part of a food served as an uncooked mixture.

### SUMMARY OF THE INVENTION

Accordingly, it is an object of the present invention provides a cooked food that contains CLA.

Generally, the invention comprises a cooked food comprising an ingredient selected from the group consisting of a prepared conjugated linoleic acid, an ester thereof, a non-toxic salt thereof, diglyceride and triglyceride esters of various isomers of conjugated linoleic acids, conjugated dienes of long-chained fatty acids, and mixtures thereof, said ingredient being present in an amount of at least 3 milligrams per gram of lipid in the food. A portion of the ingredient is present in the food after cooking.

In one embodiment of the invention, the ingredient also acts as a leavening agent for cooked foods. Typically, for a measurable amount of leavening and/or binding (reduced fragility) to take place, the starting ingredients for the baked goods need to have more than 0.75% CLA of dry weight such as flours and baking condiments.

### DETAILED DESCRIPTION

While this invention is capable of embodiments in many different forms, the preferred embodiments are shown in the examples and will be herein described in detail. The present disclosure is to be considered an exemplification of the principles of the invention and is not intended to limit the broad aspects of the invention to the embodiments illustrated.

The invention comprises a cooked food containing CLA or its derivatives. Specifically, the ingredient can be selected from the group consisting of prepared conjugated linoleic acid, an ester thereof, a non-toxic salt thereof, diglyceride and triglyceride esters of various isomers of conjugated linoleic acids, conjugated dienes of long-chained fatty acids, and mixtures thereof. The ingredient is incorporated into the food before cooking in the amount of at least three milligrams of ingredient per gram of lipid in the food. Importantly, the CLA exists substantially in the same form before and after cooking and is substantially resistant to the stresses of cooking, including high temperatures and exposure to air. Conjugated linoleic acid is well known to be sensitive to oxidative injury and temperature. In contrast, the cooked food retains a major portion of its biological properties after cooking.

The amount of CLA and its derivatives to be incorporated into a food depends on the specific recipe and the preference of those to be fed. In one embodiment, the cooked food contains milled grains. The amount of CLA to be included in the ingredients of the cooked grain food will vary depending on whether the food is a cookie, a muffin, or a type of bread, for example. The ingredients for making cooked grain foods will generally contain approximately 0.05 to about 10.0% of CLA by dry weight or from about 0.05% to about 5.0% of a food mixture. To provide a measurable amount of leavening and/or binding (reduced fragility), the ingredients may contain more than 0.75% CLA on a dry weight basis. An appreciable amount of leavening and/or binding (reduced fragility) can be obtained when the ingredients contain more than 1% CLA. The CLA content also can be expressed as the amount of CLA based on the total calories in the ingredients of a serving (e.g., 0.005 to 6 grams CLA per 100 calorie serving). As a further alternative, the amount of CLA can be expressed as a percentage of the lipid of fat in the food ingredients: 0.1 to 100% of the food lipid; or in the amount of CLA per gram of food lipid: 3 to 1000 mg CLA per gram of lipid. However, since CLA and its derivatives have been generally recognized as safe for use as a food ingredient, the amount to be included is not critical as long as enough is present in order for the CLA to be effective.

As previously stated, in one embodiment, the cooked food contains milled grains. Examples of such foods include cookies, muffins, and breads. It is believed that when CLA is cooked into the grain-containing food, the proteins, amino acids, fatty acids and sugars offer some protection to unsaturated fatty acids, such as CLA, despite the high temperatures associated with cooking. Thus, the cooked food retains a portion of its helpful biological properties after cooking.

As an added benefit, the use of CLA and its derivatives in the instant invention improves the texture and palatability of foods made from milled grains. The dough of bread, muffins, cookies, and the like will rise or leaven more when small amounts of an active form of a CLA—such as 9,11-octadecadienoic acid and 10,12-octadecadienoic acid or their derivatives—are added to the dough, which provides superior taste and texture for humans and animals.

While gluten-containing flours benefit from the addition of CLA, CLA has particular benefits for enhancing the taste and texture of non-gluten grains and flours, which have a reputation for being bland and unappetizing. These non-gluten grains include quinoa and arrow root. CLA gives gluten-free cooked foods improved taste and less of a sandy or crumbly texture.

### EXAMPLES

The practice of the present invention is further illustrated by the following examples:

### Example 1

Pancakes
1½ cup all purpose flour
3 tbsp. sugar
¾ teaspoon baking powder (sodium carbonate)
¼ teaspoon salt
1½ cups milk
3 tablespoons unsalted butter
2 eggs
3-cc triglyceride conjugated linoleic acid

The ingredients were mixed thoroughly, left to stand for 10 minutes, and poured in portions onto a hot griddle, resulting in approximately 12 five-inch pancakes.

### Example 2

Cake
Butter 1½ cup
Fructose 2 cups
Eggs 5 whole
Vanilla 2 tsp.
CLA diglyceride 1 tsp.
Flour (quinoa) 4½ cup
Xanthan ¼ tsp
Baking soda
Salt ½ tsp.
Cinnamon 2 tsp.
Dried fruit 4 cups

Ingredients were mixed together and baked at 350 degrees for 10-12 minutes; resulting in one cake.

### Example 3

Muffin Recipe
Apple sauce 4 ounces
Fructose 1 ounce
CLA ½ tsp.
Safflower oil 1½ tablespoon
glycine 1 tablespoon
banana 4 ounces
Flour 1 cup
Xanthan ¼ teaspoon
Salt ¾ teaspoon

The oil, CLA, glycine, applesauce, vanilla, and fructose were creamed together for 5 minutes. The mashed banana was added and folded into the mixture. Next, the dry ingredients were mixed together, and the mixture was baked at 325 degrees for 15 minutes, resulting in 4 large muffins.

### Example 4

Cookies
Butter ½ cup
Fructose ¾ cup
Glycine 1 tsp.
Egg 1
Triglyceride CLA ¼ tsp.
Flour 1¼ cup
Xanthan ¼ teaspoon
Baking soda ½ teaspoon
Salt ⅛ teaspoon

The butter and fructose were creamed, and the beaten eggs, vanilla, CLA, and glycine were added. All dry ingredients were mixed in, and the cookies were placed in an oven and baked at 350 degrees for 10-12 minutes, resulting in 12 large and 24 small cookies.

### Example 5

Pie Crust
1 cup quinoa flour
⅓ cup tapioca flour
½ cup butter
3 tablespoons water
¼ tsp triglyceride CLA

Ingredients blended together and molded into pie pans for subsequent filling and baking.

In another embodiment of the invention, CLA and its additives also act as a leavening agent and help the cooked foods “rise” in the absence of cooking oil, yeast or other similar baking additives. After being cut in half and stacked for measuring, the pancake having CLA measured 4.1 cm in height. In comparison, the pancake prepared with safflower oil measured only 3.1 cm in height. The following comparative example is illustrative of the ingredient's leavening effect:

### Comparative Example

CLA Pancake
2 mL CLA (diglyceride)
0.5 cup Aunt Jemima® Complete Buttermilk Pancake mix
0.38 cup of water

Ingredients were mixed and fried on a griddle; results in a pancake with a mass of 59.9 grams and a height of 4.1 cm when cut in half and stacked.

Safflower Oil Pancake
2 mL Safflower Oil (Haines Celestial™)
0.5 cup Aunt Jemima® Complete Buttermilk Pancake mix
0.38 cup of water

Ingredients were mixed and fried on a griddle; results in a pancake with a mass of 59.9 g and a height of 3.1 cm when cut in half and stacked.

While there have been described what are believed to be the preferred embodiments of the present invention, those skilled in the art will recognize that other and further changes and modifications may be made thereto without departing from the spirit of the invention, and it is intended to claim all such changes and modifications as fall within the true scope of the invention.

1. A method of making a cooked food comprising the steps of:
providing milled grain and a first ingredient,
said first ingredient consisting essentially of an additive;
said additive being selected from the group consisting of conjugated linoleic acid, esters of said conjugated linoleic acid and mixtures thereof,
said first ingredient being provided in an amount of from about 0.05% to about 5.0% of a food mixture comprising said milled grain and said first ingredient;
combining and mixing said first ingredient, said milled grain, and other ingredients making up said food mixture;
cooking said food mixture; and
said first ingredient increasing rise and improving texture of said cooked food upon cooking said food mixture.

2. The method of making a cooked food of claim 1 wherein said milled grain is a non-gluten grain.

3. The method of making a cooked food of claim 1 wherein said milled grain is a gluten grain.

4. The method of making a cooked food of claim 1 wherein said food mixture includes a fatty acid.

5. The method of making a cooked food of claim 1 wherein said food mixture includes an amino acid.

6. The method of making a cooked food of claim 1 wherein said first ingredient increases the rise of said cooked food by at least 30%, upon cooking said food mixture.

7. The method of making a cooked food of claim 1 wherein said esters of said conjugated linoleic acid include a diglyceride conjugated linoleic acid, a triglyceride conjugated linoleic acid, or mixture thereof.

8. A method of making a cooked food comprising the steps of:
providing milled grain and a first ingredient,
said first ingredient consisting essentially of an additive selected from the group consisting of conjugated linoleic acid, esters of said conjugated linoleic acid and mixtures thereof,
said first ingredient being provided in an amount sufficient to increase rise and improve texture of said cooked food upon cooking a food mixture;
combining and mixing said first ingredient, said milled grain, and other ingredients making up said food mixture; and
cooking said food mixture.

9. The method of claim 8 wherein said food mixture comprises an amino acid.

10. The method of claim 8 wherein said food mixture comprises a fatty acid.

11. The method of claim 8 wherein said food mixture comprises a gluten grain.

12. The method of claim 8 wherein said food mixture comprises a non-gluten grain.

13. The method of claim 8 wherein said first ingredient increases the rise of said cooked food by at least 30%, upon cooking said food mixture.

14. The method of claim 8, wherein said esters of said conjugated linoleic acid include a diglyceride conjugated linoleic acid, a triglyceride conjugated linoleic acid, or mixture thereof.

15. A food composition comprising a milled grain and a first ingredient;
said first ingredient consisting essentially of an additive selected from the group consisting of conjugated linoleic acid, esters of said conjugated linoleic acid, and mixtures thereof;
said first ingredient being present in said food composition in an amount from about 0.05% to about 5.0% by weight of said milled grain and increasing rise and improving texture of said food composition upon cooking said food composition.

16. The food composition of claim 15 wherein said esters of said conjugated linoleic acid comprise a diglyceride conjugated linoleic acid, a triglyceride conjugated linoleic acid, or mixture thereof.

17. The food composition of claim 15 including an amino acid.

18. The food composition of claim 15 including a fatty acid.

19. The food composition of claim 15 wherein said milled grain includes a gluten grain.

20. The food composition of claim 15 wherein said milled grain includes a non-gluten grain.
